(19) United States
(12) Patent Application Publication
(10) Pub. No.: US 2024/0255065 A1
(43) Pub. Date: Aug. 1, 2024

(54) VALVE DEVICE FOR FUEL TANK

(71) Applicant: PIOLAX, INC., Kanagawa (JP)

(72) Inventors: Takuma KON, Kanagawa (JP); Kenta MIHARA, Kanagawa (JP)

(73) Assignee: PIOLAX, INC., Kanagawa (JP)

(21) Appl. No.: 18/420,077

(22) Filed: Jan. 23, 2024

(30) Foreign Application Priority Data
Jan. 27, 2023 (JP) 2023-010807

(51) Int. Cl. F16K 24/04

(52) U.S. Cl. CPC F16K 24/044

(57) ABSTRACT

A valve device for a fuel tank includes: a housing including a peripheral wall portion, a partition wall, a valve chamber, a ventilation chamber, and an opening; and a float valve that is accommodated in the valve chamber so as to be able to rise and descend to open and close the opening. The housing includes a float valve support portion that supports the float valve. A full tank regulation opening that opens in an axial direction and that is configured to allow the inside of the fuel tank and an inside of the valve chamber to communicate with each other, is formed in the peripheral wall portion above the float valve support portion. The full tank regulation opening enables continuous refueling from the refueling nozzle when the full tank regulation opening is not immersed, and stops the continuous refueling when the full tank regulation opening is immersed.

### CROSS-REFERENCE TO RELATED APPLICATIONS

This application is based on Japanese Patent Application No. 2023-010807 filed on Jan. 27, 2023, the contents of which are incorporated herein by way of reference.

### TECHNICAL FIELD

The present invention relates to a valve device for a fuel tank, the valve device configured to be attached to a fuel tank of an automatic vehicle or the like, and configured to suppress overfilling to the fuel tank and configured to suppress a fuel from flowing out of the fuel tank.

### BACKGROUND

For example, a fuel tank of a vehicle such as an automatic vehicle is provided with a valve device (full tank regulation valve) that suppresses overfilling into the fuel tank so that a liquid level in the fuel tank does not rise above a preset full tank liquid level, a valve device (cut valve) that suppresses a fuel in the fuel tank from leaking out of the fuel tank when the automatic vehicle tilts or rolls over, and the like.

Patent Literature 1 below describes a full tank regulation valve including a housing having a peripheral wall and a partition wall, in which a valve chamber is provided below the partition wall, a ventilation chamber is provided above the partition wall, and an opening is formed in the partition wall; a float valve; a first flow hole formed in the peripheral wall; a second flow hole formed in the peripheral wall above the first flow hole; and a third flow hole formed in the peripheral wall above the second flow hole, in which the first flow hole is disposed at a height at which full tank is regulated before additional refueling, enables continuous refueling from a refueling nozzle when the first flow hole is not immersed, and stops the continuous refueling from the refueling nozzle when the first flow hole is immersed, and the second flow hole enables additional refueling.

The first flow hole for full tank regulation has a shape that opens in a radial direction with respect to the peripheral wall of the housing.

Patent Literature 1: WO2022/080302A1

The amount of a fuel supplied into the fuel tank is determined by a height of a hole for full tank regulation. In the above full tank regulation valve, since the first flow hole for full tank regulation is formed in the peripheral wall of the housing, the first flow hole can be provided at a higher position than a valve in which the hole for full tank regulation is formed in a bottom portion of the housing.

Therefore, a full tank position of the fuel supplied into the fuel tank (a fuel height when the opening is closed by the float valve) can be set to a high position. The position at which the full tank position is defined is referred to as a full tank regulation level, a lock point, a shut off height (SOH), or the like.

However, since the first flow hole opens in the radial direction with respect to the peripheral wall of the housing, when the fuel oscillates in the fuel tank when a vehicle travels, tilts, rolls over, or the like, the fuel easily flows into the valve chamber from the first flow hole, and further, the fuel flowing into the valve chamber easily flows into the ventilation chamber through the opening before the float valve rises and closes the opening, and thus, further measures against fuel leakage outside the fuel tank are required.

Therefore, an object of the present invention is to provide a valve device for a fuel tank capable of raising a full tank regulation position and regulating fuel leakage to the outside of a fuel tank.

### SUMMARY

A valve device for a fuel tank includes: a housing including a peripheral wall portion and a partition wall, in which a valve chamber that is configured to communicate with an inside of the fuel tank and that is provided below the partition wall, and a ventilation chamber that is configured to communicate with an outside of the fuel tank and that is provided above the partition wall, are provided within the peripheral wall portion, and an opening through which the valve chamber is to communicate with the ventilation chamber, is formed in the partition wall; and a float valve that is accommodated in the valve chamber so as to be able to rise and descend to open and close the opening, and that rises to close the opening when refueling the fuel tank from a refueling nozzle. The housing includes a float valve support portion that supports the float valve. A full tank regulation opening that opens in an axial direction and that is configured to allow the inside of the fuel tank and an inside of the valve chamber to communicate with each other, is formed in the peripheral wall portion above the float valve support portion. The full tank regulation opening enables continuous refueling from the refueling nozzle when the full tank regulation opening is not immersed, and stops the continuous refueling when the full tank regulation opening is immersed.

### BRIEF DESCRIPTION OF DRAWINGS

FIG. 1 is an exploded perspective view showing an embodiment of a valve device for a fuel tank according to the present invention.

FIG. 2 is a perspective view of the valve device for the fuel tank.

FIG. 3 is a perspective view of a lower cap constituting the valve device for the fuel tank, as viewed in a direction different from that in FIG. 1.

FIG. 4 is a plan view of the lower cap.

FIG. 5 is a bottom view of the lower cap.

FIG. 6 is a cross-sectional view taken along line A-A in FIG. 2.

FIG. 7 is a cross-sectional view taken along line B-B in FIG. 2.

FIG. 8 is a cross-sectional view showing a state in which a float valve descends and an opening is open.

FIG. 9 is a cross-sectional view when the float valve rises from the state in FIG. 8 and the opening is closed.

FIG. 10 is a cross-sectional view when an intermediate valve body descends with respect to a seal valve body from the state in FIG. 9.

FIG. 11 is a graph showing a relation between a pressure in the fuel tank and time when the float valve rises and descends.

FIG. 12 is a perspective view showing another embodiment of the valve device for the fuel tank according to the present invention.

FIG. 13 is a perspective view seen from a direction different from that in FIG. 12.

FIG. 14 is a perspective view of a lower cap according to another embodiment, as viewed in a direction different from that in FIG. 12.

FIG. 15 is a plan view of the lower cap.

FIG. 16 is a bottom view of the lower cap.

FIG. 17 is a cross-sectional view taken along line E-E in FIG. 14.

FIG. 18 is a cross-sectional view showing a state in which a float valve descends and an opening is open.

### DESCRIPTION OF EMBODIMENTS

(Embodiment of Valve Device for Fuel Tank)

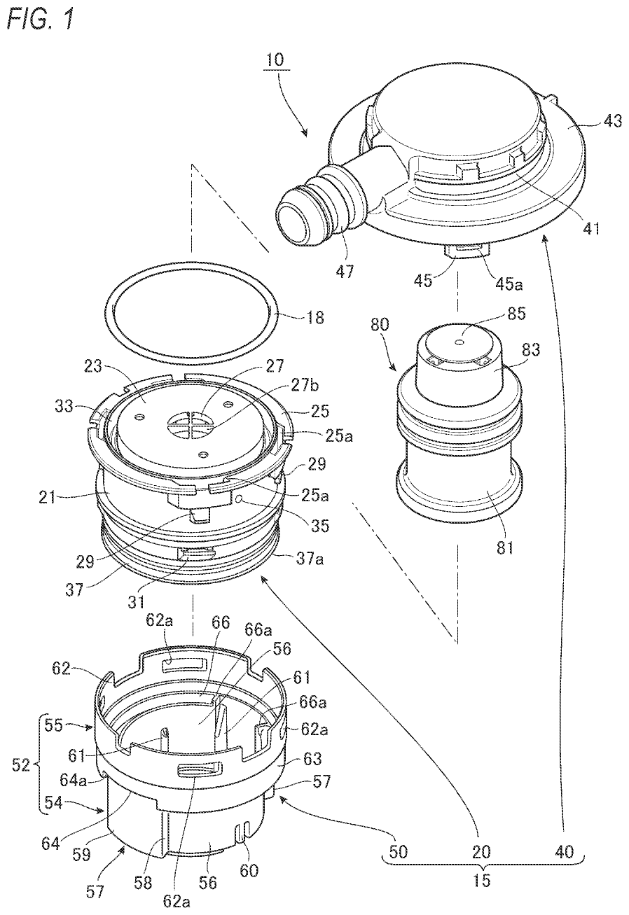

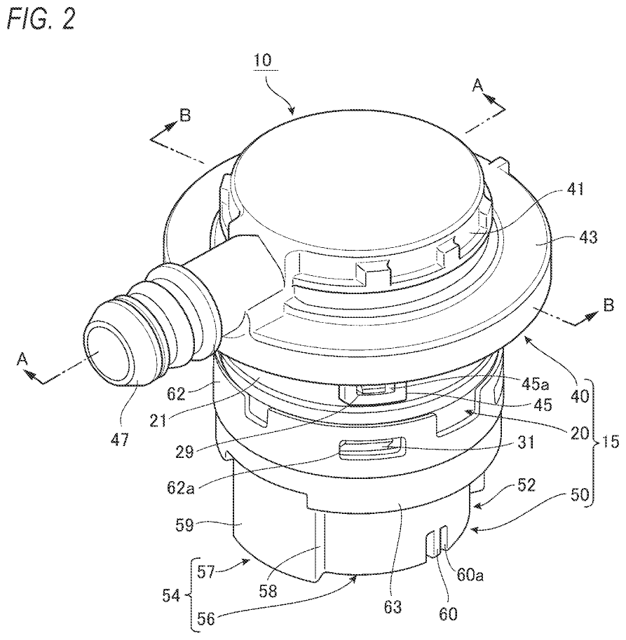

Hereinafter, an embodiment of a valve device for a fuel tank according to the present invention will be described with reference to FIGS. 1 to 11.

As shown in FIGS. 1, 6, and 7, a valve device 10 for a fuel tank (hereinafter, also simply referred to as a “valve device 10”) of the present embodiment includes a housing 15 including peripheral wall portions 21, 41, and 52 and a partition wall 23, in which a valve chamber V that communicates with the inside of a fuel tank and is provided below the partition wall 23 and a ventilation chamber R that communicates with the outside of the fuel tank and is provided above the partition wall 23 are provided within the peripheral wall portions 21, 41, and 52, and an opening 27 through which the valve chamber V communicates with the ventilation chamber R is formed in the partition wall 23; a float valve 80 that is accommodated in the valve chamber V so as to be able to rise and descend to open and close the opening 27, and rises to close the opening 27 when refueling the fuel tank from a refueling nozzle; and a biasing spring 17 for biasing the float valve 80.

The housing 15 of the present embodiment includes a housing main body 20 having the partition wall 23, an upper cover 40 attached above the housing main body 20, and a lower cap 50 attached below the housing main body 20.

The housing 15 has a float valve support portion 51 that supports the float valve 80. Further, the housing main body 20 has the peripheral wall portion 21, the upper cover 40 has the peripheral wall portion 41, and the lower cap 50 has the peripheral wall portion 52.

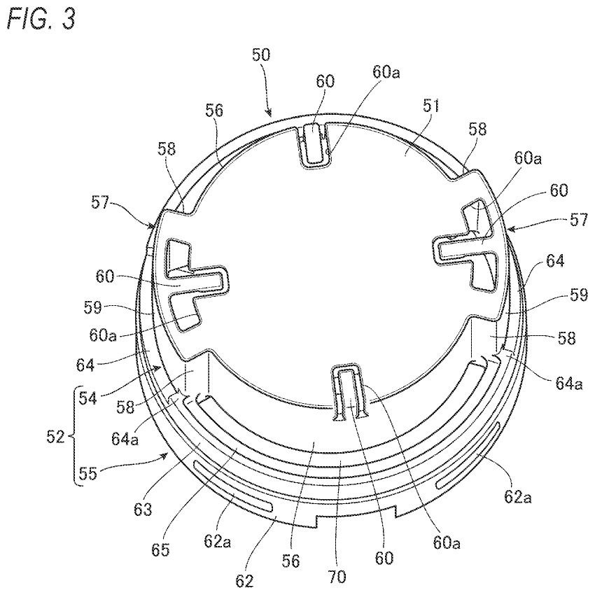

As shown in FIGS. 3 to 5 and 7, full tank regulation openings 70 that open in an axial direction and allow the inside of the fuel tank and the inside of the valve chamber V to communicate with each other are formed in the peripheral wall portion 52 of the lower cap 50 above the float valve support portion 51, and the full tank regulation opening 70 enables continuous refueling from the refueling nozzle when the full tank regulation opening 70 is not immersed, and stops the continuous refueling when the full tank regulation opening 70 is immersed.

That is, in the present embodiment, the peripheral wall portion 52 of the lower cap 50 constitutes a “peripheral wall portion” in the present invention.

In the following description, a “fuel” means a liquid fuel (including fuel droplets), and “fuel vapor” means evaporated fuel. The “axial direction” in the present invention means a direction along a rising and descending movement of the float valve 80 that rises and descends in the valve chamber V in a vertical direction, or a direction along an axis of the float valve 80 (also referred to as a valve axial direction) (the same applies to the following description).

First, the housing main body 20 will be described with reference to FIGS. 1, 6, and 7.

The housing main body 20 includes the peripheral wall portion 21 having a substantially cylindrical shape, and the partition wall 23 is disposed above the peripheral wall portion 21. A flange portion 25 having a substantially annular shape protrudes from an upper side of the peripheral wall portion 21. A plurality of insertion holes 25a are formed in the flange portion 25.

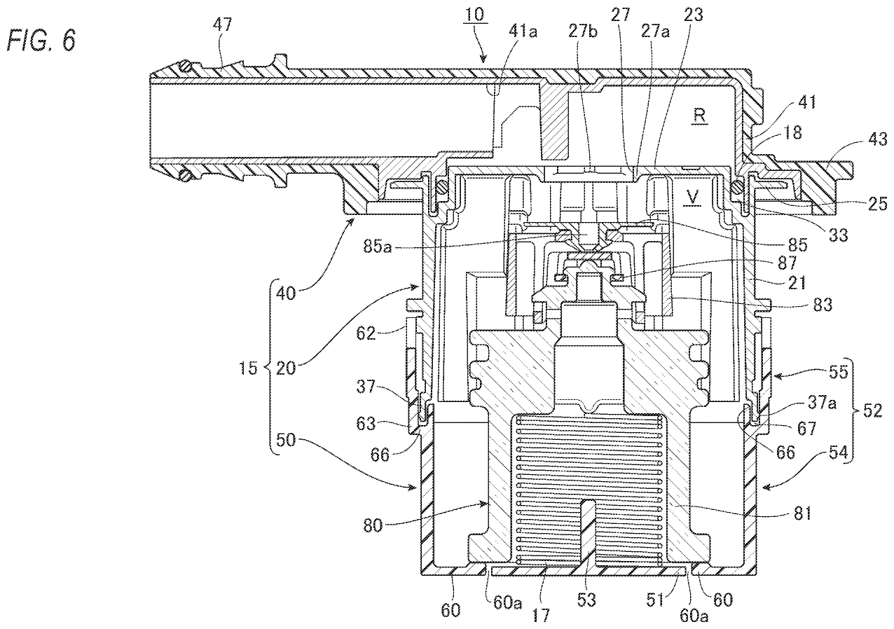

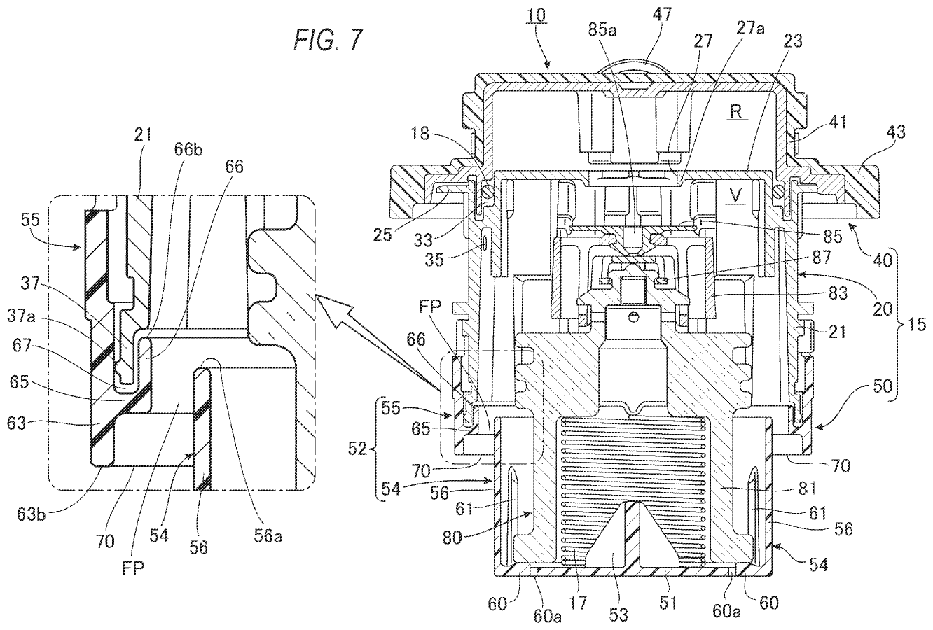

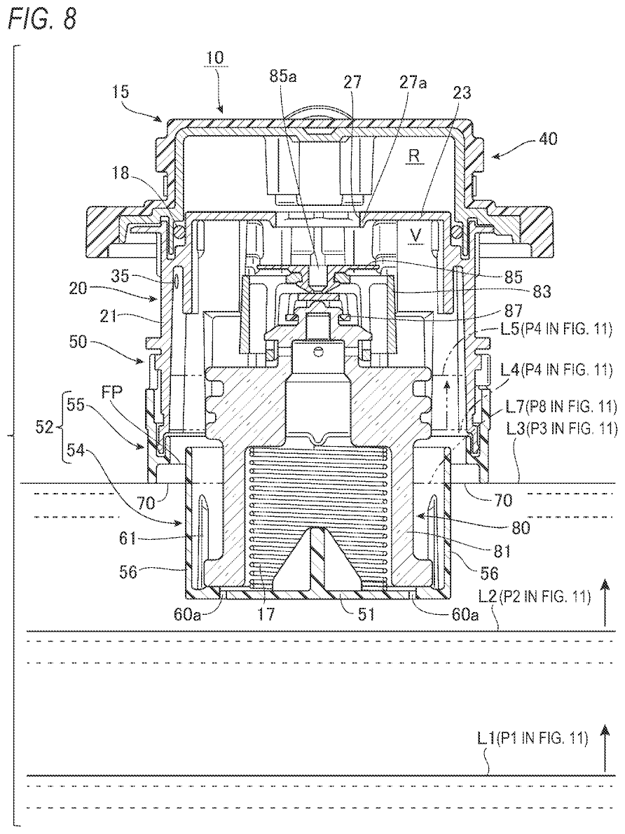

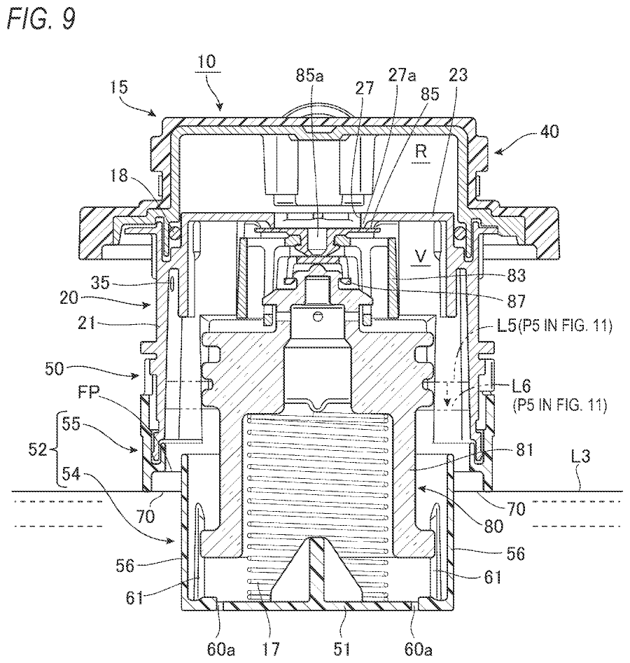

An opening 27 having a substantially circular hole shape is formed in a central portion in a radial direction of the partition wall 23. A valve seat 27a having a substantially circular protrusion shape protrudes from a back side (lower side) peripheral edge of the opening 27 (see FIGS. 6 and 7). The opening 27 is opened and closed when the float valve 80 is in contact with and separates from the valve seat 27a (see FIGS. 8 and 9).

A substantially cross-shaped rib 27b is provided on an inner periphery of the opening 27. The rib 27b suppresses a seal valve body 85 (see FIGS. 6 and 7) from popping out from a front-side inner peripheral edge of the opening 27.

A plurality of first engaging protrusions 29 protrude from positions on an outer periphery of the peripheral wall portion 21 close to the flange portion 25 and aligned with the insertion holes 25a. Further, a plurality of second engaging protrusions 31 protrude from the outer periphery of the peripheral wall portion 21 at positions close to a lower end portion 37 in the axial direction.

A ring attachment groove 33 having an annular groove shape is formed between the partition wall 23 and the flange portion 25, and a seal ring 18 is inserted into the ring attachment groove 33 (see FIGS. 6 and 7).

A flow hole 35 is formed in the peripheral wall portion 21 at a portion close to the partition wall 23 to allow the inside of the fuel tank and the inside of the valve chamber V to communicate with each other (see FIGS. 1 and 7). The flow hole 35 is configured to maintain a state in which the flow hole 35 is not immersed except when a vehicle tilts or rolls over, or when refueling the fuel tank, and serves as a portion through which air in the fuel tank flows into the valve chamber V.

Further, as shown in FIG. 1, an annular protrusion 37a protrudes from an outer periphery of the lower end portion 37 in the axial direction of the peripheral wall portion 21.

Next, the upper cover 40 attached above the housing main body 20 will be described with reference to FIGS. 1, 2, 6, and 7.

The upper cover 40 includes the peripheral wall portion 41 having a substantially cylindrical shape, and a ceiling portion thereof is closed. The upper cover 40 further includes a flange portion 43 protruding outward in a radial direction from an outer peripheral edge of a lower end of the peripheral wall portion 41, and has a substantially hat shape with an open bottom and a closed top.

As shown in FIG. 1, a plurality of engaging pieces 45 extend downward from an inner peripheral edge of the flange portion 43. Each of the engaging pieces 45 has an engaging hole 45a formed therein.

The engaging pieces 45 of the upper cover 40 are inserted through the corresponding insertion holes 25a of the housing main body 20, and the corresponding first engaging protrusions 29 are respectively engaged with the engaging holes 45a. As a result, as shown in FIGS. 6 and 7, the upper cover 40 is attached above the housing main body 20 via the seal ring 18, and the ventilation chamber R communicating with the outside of the fuel tank is formed above the partition wall 23.

A fuel vapor discharge port 41a (hereinafter, also simply referred to as a “discharge port 41a”) having a substantially circular hole shape is formed at a predetermined portion in a peripheral direction of the peripheral wall portion 41 so as to penetrate through the peripheral wall portion 41 (see FIG. 6). A fuel vapor pipe 47 (hereinafter, also simply referred to as a “pipe 47”) extends by a predetermined length from a front-side peripheral edge of the discharge port 41a of the peripheral wall portion 41. The pipe 47 communicates with the discharge port 41a.

Next, the lower cap 50 attached below the housing main body 20 will be described with reference to FIGS. 1 to 7.

The lower cap 50 having a plate shape includes the float valve support portion 51 positioned at a cap bottom portion to support the float valve 80 and the peripheral wall portion 52 erected from an outer peripheral edge of the float valve support portion 51, and has a bottomed cap shape. It can also be said that the float valve support portion 51 is positioned at a lower end portion in the axial direction of the peripheral wall portion 52.

The full tank regulation opening 70 is formed above the float valve support portion 51. That is, in the present embodiment, the full tank regulation opening 70 is provided in the lower cap 50.

A substantially cross-shaped spring support protrusion 53 that supports a lower end portion of the biasing spring 17 protrudes from a central portion in a radial direction of an inner surface (a surface facing the valve chamber V) of the float valve support portion 51.

As shown in FIG. 7, the peripheral wall portion 52 includes an inner wall portion 54 and an outer wall portion 55 disposed outside the inner wall portion 54 and has a double-wall structure when the housing 15 is viewed from a cross section in a radial direction, and the full tank regulation opening 70 is provided between the inner wall portion 54 and the outer wall portion 55.

In the case of the present embodiment, when viewed from a vertical cross section of the housing 15 as shown in FIG. 7, that is, the cross section in the radial direction of the housing 15, the peripheral wall portion 52 has a double cylinder structure including the inner wall portion 54 and the outer wall portion 55.

The inner wall portion 54 includes a pair of arc-shaped wall portions 56, 56 and a pair of expansion wall portions 57, 57.

Specifically, the pair of arc-shaped wall portions 56, 56 that have an arc shape and extend in the axial direction are erected from portions facing each other in the radial direction on the outer peripheral edge of the float valve support portion 51. At positions orthogonal to the pair of arc-shaped wall portions 56, 56 on the outer peripheral edge of the float valve support portion 51, the pair of expansion wall portions 57, 57 that expand outward in the radial direction from the arc-shaped wall portions 56 are provided so as to form a substantially fan shape when viewed in the axial direction.

Each of the expansion wall portions 57 has a substantially fan shape as described above, and includes a pair of outward extending portions 58, 58 that expand from each other and extend outward in the radial direction from an end in a peripheral direction of a predetermined arc-shaped wall portion 56 and an end in a peripheral direction of an arc-shaped wall portion 56 adjacent to the end in the peripheral direction, and an arc-shaped portion 59 that has a substantially arc shape and connects the pair of outward extending portions 58, 58.

Resiliently deformable elastic pieces 60 are formed in a portion between the arc-shaped wall portion 56 and the float valve support portion 51 and in a portion between the pair of outward extending portions 58, 58, the arc-shaped portion 59, and the float valve support portion 51 through communication ports 60a formed as a notch, a slit, or the like, thereby suppressing hitting noise when the float valve 80 descends and is placed on the float valve support portion 51.

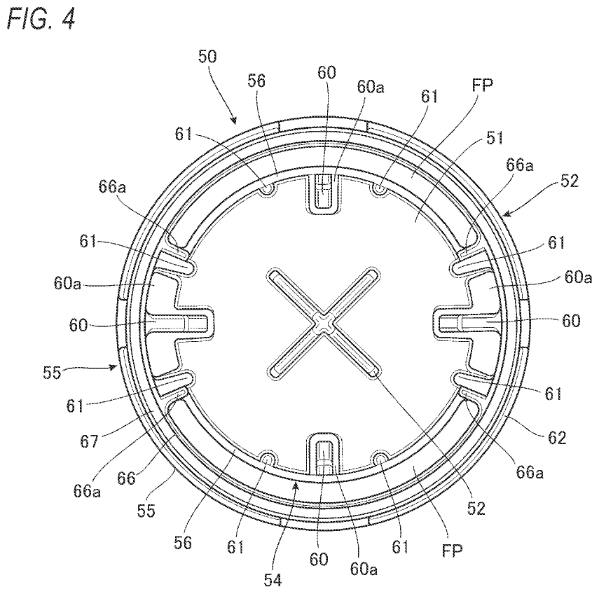

Further, as shown in FIGS. 1 and 4, a plurality of guide ribs 61 are provided on an inner periphery of the peripheral wall portion 52 so as to protrude inward in the radial direction and extend in the axial direction to guide the rising and descending movement of the float valve 80. In the case of the present embodiment, the guide ribs 61 are provided at positions adjacent to an inner surface of the arc-shaped wall portion 56 of the inner wall portion 54 and inner surfaces of the pair of outward extending portions 58, 58 constituting the expansion wall portion 57.

On the other hand, the outer wall portion 55 includes an upper end portion 62 that is disposed upward in the axial direction and has a substantially annular shape, and a lower end portion 63 that is continuously provided below the upper end portion 62 and has a diameter smaller than that of the upper end portion 62.

In the upper end portion 62, engaging holes 62a having an elongated hole shape extending in a peripheral direction are formed at equal intervals in the peripheral direction.

The lower cap 50 is attached below the housing main body 20 by respectively engaging the corresponding second engaging protrusions 31 of the housing main body 20 with the engaging holes 62a. As a result, the valve chamber V communicating with the inside of the fuel tank (not shown) is formed below the housing 15 via the partition wall 23 (see FIGS. 6 and 7).

As shown in FIG. 3, recesses 64, 64 that are recessed inward in a radial direction at a predetermined depth and extend in a peripheral direction at a predetermined length are formed at a lower end of the lower end portion 63 in the axial direction, at portions corresponding to the pair of expansion wall portions 57, 57 and facing each other in the radial direction. A pair of connection portions 64a, 64a for connecting to the expansion wall portions 57 are provided at both ends in the peripheral direction of each of the recesses 64.

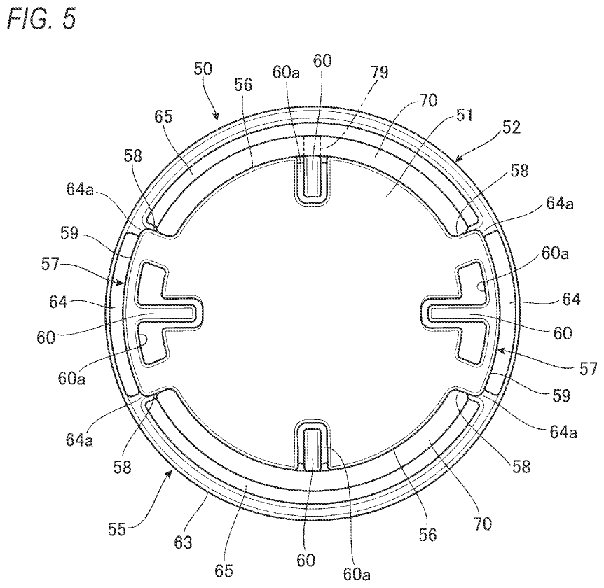

Further, a stepped portion 65 having a substantially annular flange shape protrudes inward in a radial direction from an inner periphery of the lower end portion 63 (see FIGS. 3 and 5). An annular intermediate wall portion 66 protrudes upward in the axial direction at a predetermined height from an inner peripheral edge of the stepped portion 65 (see FIG. 7), and an annular groove 67 having an annular shape with an open top is formed between the intermediate wall portion 66, the stepped portion 65, and the lower end portion 63 of the outer wall portion 55.

As shown in FIG. 4, the intermediate wall portion 66 is disposed between the outer wall portion 55 and the inner wall portion 54 when the lower cap 50 is viewed in the axial direction. It can be said that the intermediate wall portion 66 is disposed on an inner side in a radial direction of the outer wall portion 55 and is disposed on an outer side in a radial direction of the inner wall portion 54.

The lower end portion 37 of the peripheral wall portion 21 of the housing main body 20 is inserted into the annular groove 67 when the lower cap 50 is attached below the housing main body 20, and the annular protrusion 37a abuts against an inner peripheral surface on an outer side in a radial direction of the annular groove 67 (see FIGS. 6 and 7).

As shown in FIG. 4, a pair of connection portions 66a, 66a protrude inward in a radial direction from portions of an inner periphery of the intermediate wall portion 66 facing both ends in the peripheral direction of each of the arc-shaped wall portions 56.

The pair of connection portions 66a, 66a are connected to upper end portions of both ends in the peripheral direction of the arc-shaped wall portion 56 (see FIGS. 1 and 4), and the pair of connection portions 64a, 64a of the lower end portion 63 are connected to both ends in the peripheral direction of the arc-shaped portion 59 of the expansion wall portion 57 (see FIG. 3), so that the outer wall portion 55 and the inner wall portion 54 are connected to form a double-wall structure.

As shown in FIG. 7, the lower end portion 63 of the outer wall portion 55 overlaps with an upper end portion of the inner wall portion 54 by a predetermined length in the axial direction. Here, a portion of the lower end portion 63 of the outer wall portion 55 facing the arc-shaped wall portion 56 of the inner wall portion 54 overlaps with the upper end portion of the arc-shaped wall portion 56 of the inner wall portion 54 by a predetermined length in the axial direction.

As shown in FIG. 7, an upper end 56a of the arc-shaped wall portion 56 of the inner wall portion 54 is positioned lower than an upper end 66b of the intermediate wall portion 66 in the axial direction and higher than a lower end 63b of the lower end portion 63 of the outer wall portion 55 in the axial direction.

As shown in FIG. 7, the full tank regulation opening 70 is provided between the lower end portion 63 of the outer wall portion 55 and the inner wall portion 54.

To explain a height position of the full tank regulation opening 70, as shown in FIG. 7, the full tank regulation opening 70 for setting a full tank regulation level, a lock point, or a shut off height (SOH) is disposed between the lower end 63b of the lower end portion 63 of the outer wall portion 55 and a portion at a predetermined height of the arc-shaped wall portion 56 of the inner wall portion 54 corresponding to the lower end 63b.

The full tank regulation opening 70 is surrounded by the following portions. That is, as shown in FIG. 5, when the lower cap 50 is viewed from a lower side in the axial direction (when viewed from a bottom surface), the full tank regulation opening 70 is defined inside a portion surrounded by the portion of the lower end portion 63 of the outer wall portion 55 facing the arc-shaped wall portion 56 of the inner wall portion 54, the pair of connection portions 64a, 64a of the recesses 64, the pair of outward extending portions 58, 58 of the expansion wall portion 57, and the arc-shaped wall portion 56 of the inner wall portion 54.

The full tank regulation opening 70 opens in the axial direction of the housing 15, that is, the full tank regulation opening 70 opens in the vertical direction. As shown in FIG. 7, the full tank regulation opening 70 in the present embodiment has a shape that opens downward in the axial direction of the peripheral wall portion 52 of the lower cap 50 (opens on a lower side in the axial direction).

The full tank regulation opening 70 communicates with a flow path FP shown in FIG. 7. Therefore, the full tank regulation opening 70 allows the inside of the fuel tank and the inside of the valve chamber V to communicate with each other through the flow path FP.

Further, the full tank regulation opening 70 has an arc shape when the housing 15 is viewed in the axial direction.

That is, as shown in FIG. 5, when the lower cap 50 is viewed from the lower side in the axial direction, the full tank regulation opening 70 is a substantially arc-shaped opening that extends for a predetermined length along the peripheral direction of the peripheral wall portion 52 with a constant gap in the radial direction of the peripheral wall portion 52. In the present embodiment, a pair of the full tank regulation openings 70, 70 are provided at portions facing each other in the radial direction of the peripheral wall portion 52.

It can also be said that the intermediate wall portion 66 has the following configuration. That is, it can also be said that the intermediate wall portion 66 is provided between the lower end portion 63 of the outer wall portion 55 and the inner wall portion 54 and above the full tank regulation opening 70 via the stepped portion 65 to reduce a flow path width of the flow path communicating with the full tank regulation opening 70 and the valve chamber V.

With reference to FIG. 7, between the intermediate wall portion 66 protruding upward from the inner peripheral edge of the stepped portion 65 and the arc-shaped wall portion 56 of the inner wall portion 54 disposed facing the intermediate wall portion 66, the flow path FP that allows the full tank regulation opening 70 and the valve chamber V to communicate with each other is disposed. The flow path FP is positioned above the full tank regulation opening 70, and a flow path area thereof is smaller than an opening area of the full tank regulation opening 70.

As shown in FIG. 4, when the lower cap 50 is viewed from an upper side in the axial direction, the flow path FP is defined inside a portion surrounded by a portion of the intermediate wall portion 66 disposed inside the outer wall portion 55 facing the arc-shaped wall portion 56 of the inner wall portion 54, the pair of connection portions 66a, 66a of the intermediate wall portion 66, and the arc-shaped wall portion 56 of the inner wall portion 54.

The full tank regulation opening 70 is disposed at a height at which full tank is regulated, and is formed with an opening area that allows the inside of the fuel tank and the inside of the valve chamber V to communicate with each other and enables continuous refueling from the refueling nozzle when the full tank regulation opening 70 is not immersed.

Next, the float valve 80 accommodated in the valve chamber V so as to be able to rise and descend will be described with reference to FIGS. 6 and 7.

The float valve 80 of the present embodiment includes a float main body 81 that generates buoyancy when the float valve 80 is immersed in a fuel, and a seal member 83 that is attached above the float main body 81, rises and descends relative to the float main body 81, and is in contact with and separates from the opening 27 of the partition wall 23.

The seal valve body 85 made of an elastic material such as rubber or an elastic elastomer is attached above the seal member 83. A ventilation hole 85a with an opening at an upper side and a lower side penetrates through a center of the seal valve body 85. The seal valve body 85 is in contact with and separates from the valve seat 27a of the opening 27 to open and close the opening 27, whereby the float valve 80 functions as a full tank regulation valve.

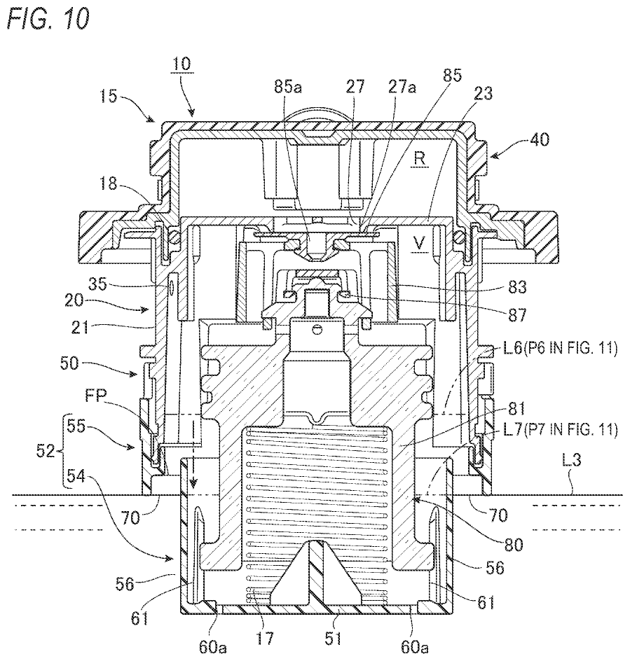

Further, between the float main body 81 and the seal member 83, an intermediate valve body 87 is supported so as to be tiltable. The intermediate valve body 87 normally abuts against a lower end portion of the seal valve body 85 to close the ventilation hole 85a (see FIGS. 6 and 7), and opens the ventilation hole 85a when the float main body 81 descends with respect to the seal member 83 (see FIG. 10).

The float valve 80 is accommodated and disposed in the valve chamber V so as to be able to rise and descend in a state in which the biasing spring 17 is interposed between the float valve 80 and the lower cap 50. The float valve 80 rises due to the buoyancy thereof and a biasing force of the biasing spring 17 when immersed in a fuel, and descends due to a weight thereof when not immersed in a fuel.

In the valve device 10 described above, when a fuel liquid level in the fuel tank rises during refueling and the full tank regulation opening 70 is immersed, the float valve 80 rises to close the opening 27, and the continuous refueling is stopped (see FIG. 9). Specifically, when the full tank regulation opening 70 is immersed, an air inflow speed from the flow hole 35 cannot keep up with a continuous refueling speed from the refueling nozzle, a fuel liquid level in the valve chamber V rises, the opening 27 is closed by the float valve 80, and the continuous refueling from the refueling nozzle is stopped.

In the full tank regulation opening 70, “when . . . is not immersed” means a state in which the full tank regulation opening 70 opens without being closed by a liquid fuel and the inside of the fuel tank and the inside of the valve chamber communicate with each other, and “when . . . is immersed” means a state in which the full tank regulation opening 70 is closed by the liquid fuel and the communication between the inside of the fuel tank and the inside of the valve chamber is blocked.

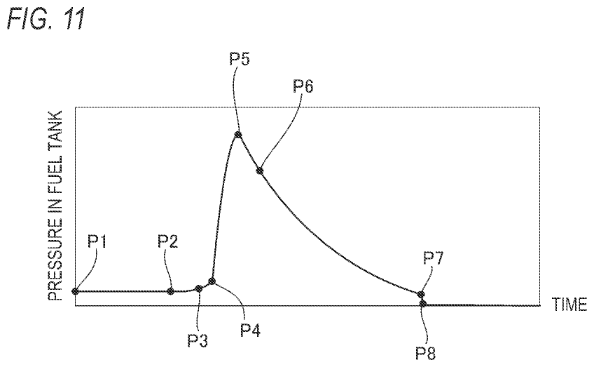

Hereinafter, with reference to FIGS. 8 to 10, a relation among fuel liquid levels (L1, L2, L3, L4, L5, L6, and L7), operations of the full tank regulation opening 70 and the float valve 80, and an opening and closing state of the opening 27 will be described. FIG. 11 is a graph showing a relation between a pressure (vertical axis) in the fuel tank and time (horizontal axis) at this time, and this graph is also referred to.

The fuel liquid levels L1, L2, and L3 indicate fuel liquid levels outside the valve chamber V, and the fuel liquid levels L4, L5, L6, and L7 indicate fuel liquid levels inside the valve chamber V.

P1, P2, and P3 in FIG. 11 mean pressures in the fuel tank at the fuel liquid levels L1, L2, and L3 in FIG. 8, respectively. P4 in FIG. 11 means a pressure in the fuel tank at the fuel liquid levels L4 and L5 in FIG. 8. Further, P5 in FIG. 11 means a pressure in the fuel tank at the fuel liquid levels L5 and L6 in FIG. 9.

In addition, P6 in FIG. 11 means a pressure in the fuel tank at the fuel liquid level

L6 in FIG. 10. P7 in FIG. 11 means a pressure in the fuel tank at the fuel liquid level L7 in FIG. 10. P8 in FIG. 11 means a pressure in the fuel tank at the fuel liquid level L7 in FIG. 8.

FIG. 8 shows a state in which the float valve 80 is not immersed in a fuel. In this state, the float valve 80 descends due to the weight thereof, the opening 27 is opened, and the valve chamber V and the ventilation chamber R communicate with each other through the opening 27. The communication port 60a of the float valve support portion 51 is opened without being immersed, and the full tank regulation opening 70 is also opened. Further, a lower end portion of the seal valve body 85 abuts against the intermediate valve body 87 to close the ventilation hole 85a of the seal valve body 85.

Then, when refueling the fuel tank, the fuel liquid level in the fuel tank rises sequentially to L1, L2 (see FIG. 8), and the pressure in the fuel tank also changes to P1, P2 (see FIG. 11). The air in the fuel tank flows into the valve chamber V through the communication port 60a and the full tank regulation opening 70, then flows into the ventilation chamber R through the opening 27, further flows into the pipe 47 through the discharge port 41a, and is discharged to a canister outside the fuel tank.

In this way, the air in the fuel tank is discharged to the outside of the fuel tank, making it possible to continuously refuel the fuel tank.

Thereafter, when the fuel liquid level reaches the communication port 60a, the fuel flows into the valve chamber V through the communication port 60a, and the float main body 81 is immersed in the fuel, whereby the float valve 80 gradually rises.

Then, when the fuel liquid level L3 reaches the full tank regulation opening 70, the full tank regulation opening 70 is immersed, and the pressure inside the fuel tank reaches P3, the air flow between the inside of the fuel tank and the valve chamber V through the full tank regulation opening 70 is blocked.

As a result, the fuel liquid level in the valve chamber V rises (see the fuel liquid level L4), and the pressure in the fuel tank increases to P4. When the fuel liquid level in the valve chamber V further rises (see the fuel liquid level L5), the float valve 80 further rises, the seal valve body 85 abuts against the valve seat 27a, and the opening 27 is closed (see FIG. 9). As a result, the air flow between the valve chamber V and the ventilation chamber R through the opening 27 is blocked, and the pressure in the fuel tank increases to P5 (the pressure in the fuel tank is at the maximum).

Thus, the fuel in the fuel tank rises along a refueling pipe extending obliquely outward from a side surface of the fuel tank and comes into contact with the full tank detection sensor of the refueling nozzle, and the full tank is detected, and thus refueling to the fuel tank is stopped and the full tank can be regulated.

Thereafter, as time elapses or the fuel liquid level in the valve chamber V is pushed by the air flowing in from the flow hole 35, the fuel liquid level in the valve chamber V descends (see the fuel liquid level L6), and the amount of the fuel in which the float main body 81 is immersed decreases.

At this time, since the seal valve body 85 is maintained in a state of being stuck to the valve seat 27a, as shown in FIG. 10, the float main body 81 descends due to a weight thereof with respect to the seal member 83 to which the seal valve body 85 is attached. Then, the intermediate valve body 87 separates from the seal valve body 85, and the ventilation hole 85a of the seal valve body 85 is opened. As a result, the opening 27 communicates with the valve chamber V and the ventilation chamber R through the ventilation hole 85a, so that the pressure in the fuel tank decreases to P6.

Thereafter, when the fuel liquid level in the valve chamber V descends to the same height as the fuel liquid level L3 outside the valve chamber V (see the fuel liquid level L7) and the pressure in the fuel tank further descends to P7, the seal valve body 85 attached to the valve seat 27a is peeled off and the entire float valve 80 descends, returning to the state shown in FIG. 8 (the pressure in the fuel tank at this time is P8, which is lower than P7).

### (Modification)

Shapes, structures, layouts, and the like of the housing constituting the present invention, the housing main body constituting the housing, the upper cover, the lower cap, the float valve support portion, the peripheral wall portion, the inner wall portion, the outer wall portion, the float valve, and the like are not limited to the above aspects.

The housing 15 in the above embodiment includes the housing main body 20, the upper cover 40, and the lower cap 50, but the housing may include at least a peripheral wall portion, a partition wall, and a float valve support portion. For example, the housing main body itself may have a cylindrical structure with a bottom (a structure in which the housing main body and the lower cap are integrated).

The float valve support portion 51 in the present embodiment is provided on a bottom portion of the lower cap 50, but for example, the float valve support portion may be provided in an intermediate portion of the lower cap in the axial direction as long as the float valve support portion can support the float valve.

Further, the peripheral wall portion 21 of the housing main body 20, the peripheral wall portion 41 of the upper cover 40, and the like in the present embodiment have a substantially cylindrical shape, but the shape may be an elliptical cylindrical shape and an angular cylindrical shape, for example.

The float valve 80 in the present embodiment has a multi-component configuration including the float main body 81, the seal member 83, the intermediate valve body 87, and the like, but the float valve may be, for example, a float valve in which a seal member made of an elastic material is attached on an upper side, and may be any valve as long as the opening 27 can be opened and closed.

Further, in the present embodiment, one float valve 80 is accommodated and disposed in one valve chamber V formed in the housing 15, but a plurality of float valves may be accommodated and disposed in one valve chamber (the float valves function as a fuel cut valve, a pressure regulating valve, or the like in addition to the full tank regulation valve), or a plurality of valve chambers may be defined in a housing and each valve chamber has a float valve accommodated and disposed therein, for example.

The full tank regulation opening 70 in the present embodiment has an arc shape when the housing 15 is viewed in the axial direction, but the full tank regulation opening may have, for example, a circular shape, an elliptical shape, a substantially elliptical shape, an elongated hole shape, a rectangular shape, a polygonal shape, or the like when the housing is viewed in the axial direction, as long as the full tank regulation opening opens in the axial direction and allows the inside of the fuel tank and the inside of the valve chamber to communicate with each other.

Further, in the present embodiment, the full tank regulation opening 70 is provided between the lower end portion of the outer wall portion 55 and the inner wall portion 54 (see

FIG. 7), but the full tank regulation opening may be provided, for example, between a lower end portion of the inner wall portion and the outer wall portion (this will be described in other embodiments).

As shown by a two-dot chain line in FIG. 5, the peripheral wall portion 52 may have a structure in which the inner wall portion 54 and the outer wall portion 55 are connected and a connection rib 79 that partitions the full tank regulation opening 70 into a plurality of sections is provided.

### (Operations and Effects)

Next, operations and effects of the valve device 10 configured as described above will be described.

That is, when refueling the fuel tank from the state shown in FIG. 8 and the fuel liquid level reaches a preset SOH, that is, when the fuel liquid level L3 reaches the full tank regulation opening 70, the full tank regulation opening 70 is immersed, the air flow between the fuel tank and the valve chamber V is blocked, and the fuel liquid level in the valve chamber V rises (see the fuel liquid levels L4 and L5).

Then, the float valve 80 rises, the seal valve body 85 abuts against the valve seat 27a, and the opening 27 is closed, so that the air flow between the valve chamber V and the ventilation chamber R through the opening 27 is blocked, the fuel in the fuel tank rises along the refueling pipe and comes into contact with the full tank detection sensor of the refueling nozzle, and the full tank is detected, and as a result, refueling to the fuel tank is stopped and the full tank can be regulated.

At this time, in the valve device 10, since the full tank regulation opening 70 that opens in the axial direction is formed above the float valve support portion 51 in the peripheral wall portion 52, a full tank regulation position can be raised.

Since the full tank regulation opening 70 opens in the axial direction, even if the fuel oscillates, the oscillating fuel collides with the peripheral wall portion 52 and the momentum is weakened, so that the fuel is less likely to directly flow into the valve chamber

V from the full tank regulation opening 70. It can also be said that since the full tank regulation opening 70 opens in the axial direction, it is possible to make it difficult for the fuel to flow into the valve chamber V from the full tank regulation opening 70 when the fuel oscillates or the like, compared to a case where the full tank regulation opening opens in the radial direction.

Therefore, it is possible to make it difficult for the fuel to flow into the ventilation chamber R through the opening 27 of the partition wall 23, thereby making it difficult to leak out of the fuel tank.

As described above, in the valve device 10 according to the present invention, it is possible to raise the full tank regulation position and take measures against the fuel leakage to the outside of the fuel tank. For example, it is possible to achieve a countermeasure against fuel leakage having a higher effect than that of the full tank regulation valve disclosed in Patent Literature 1 (WO2022/080302A1), which is a patent application filed by the present applicant. It can be said that it is possible to achieve an effect of raising the full tank regulation position and a contradictory effect of regulating fuel leakage to the outside of the fuel tank.

In the present embodiment, as shown in FIG. 7, the peripheral wall portion 52 includes the inner wall portion 54 and the outer wall portion 55 disposed outside the inner wall portion 54, and has a double-wall structure when the housing 15 is viewed from a cross section in the radial direction. The full tank regulation opening 70 is provided between the inner wall portion 54 and the outer wall portion 55.

According to the above aspect, since the full tank regulation opening 70 is provided between the inner wall portion 54 and the outer wall portion 55 having the double-wall structure, the fuel is likely to collide with the outer wall portion 55 when the fuel oscillates or the like, and it is possible to make it more difficult for the fuel to directly flow into the valve chamber V. As a result, fuel leakage to the outside of the fuel tank can be regulated more effectively (an effect of claim 2).

Further, in the present embodiment, as shown in FIG. 5, the full tank regulation opening 70 has an arc shape when the housing 15 is viewed in the axial direction.

According to the above aspect, since the full tank regulation opening 70 has an arc shape when the housing 15 (here, the lower cap 50 constituting the housing 15) is viewed in the axial direction, a large opening area of the full tank regulation opening 70 can be secured. As a result, since the air permeability between the inside of the fuel tank and the inside of the valve chamber V can be enhanced, the air in the fuel tank can smoothly flow into the valve chamber V from the fuel tank when refueling, making it easier to refuel.

The full tank regulation opening 70 can be easily formed along a peripheral shape of the peripheral wall portion 52 of the housing 15, and the entire device can be easily made compact. Further, at the time of refueling, variation when the full tank regulation opening 70 is immersed is reduced, and the full tank can be reliably regulated.

In the present embodiment, as shown in FIGS. 1, 6 and 7, the housing 15 includes the housing main body 20 including the partition wall 23, and the lower cap 50 attached below the housing main body 20. As shown in FIGS. 3 and 5, the full tank regulation opening 70 is provided in the lower cap 50.

According to the above aspect, since the full tank regulation opening 70 is provided in the lower cap 50, the full tank regulation position can be appropriately changed by replacing only the lower cap 50 while maintaining the housing main body 20.

That is, the required full tank regulation position may differ depending on the shape, structure, layout, and the like of the fuel tank. In this case, by preparing a plurality of lower caps 50 with different full tank regulation positions and replacing only the lower cap 50, the full tank regulation position can be flexibly changed according to demand.

In this case, it is not necessary to replace the housing main body 20, and thus the versatility of the housing main body 20 can be increased.

Further, in the present embodiment, as shown in FIG. 7, the full tank regulation opening 70 is provided between the lower end portion 63 of the outer wall portion 55 and the inner wall portion 54.

According to the above aspect, since the full tank regulation opening 70 is provided between the lower end portion 63 of the outer wall portion 55 and the inner wall portion 54, the lower end portion 63 of the outer wall portion 55 positioned outside the full tank regulation opening 70 can be easily positioned relatively upward, and as a result, the full tank regulation position can be easily set to a high position on the peripheral wall portion 52, so that the refueling amount into the fuel tank can be increased.

In the present embodiment, as shown in FIG. 7, the intermediate wall portion 66 is provided between the lower end portion 63 of the outer wall portion 55 and the inner wall portion 54 and above the full tank regulation opening 70 via the stepped portion 65 to reduce the flow path width of the flow path communicating with the full tank regulation opening 70 and the valve chamber V.

According to the above aspect, since the intermediate wall portion 66 that reduces the flow path width is provided, via the stepped portion 65, on a back side of the full tank regulation opening 70, that is, on a back side in an inflow direction of the fuel that passes through the full tank regulation opening from the fuel tank side and flows into the valve chamber, and it is possible to make it more difficult for the fuel to flow into the valve chamber V when the fuel oscillates or the like.

### (Another Embodiment of Valve Device for Fuel Tank)

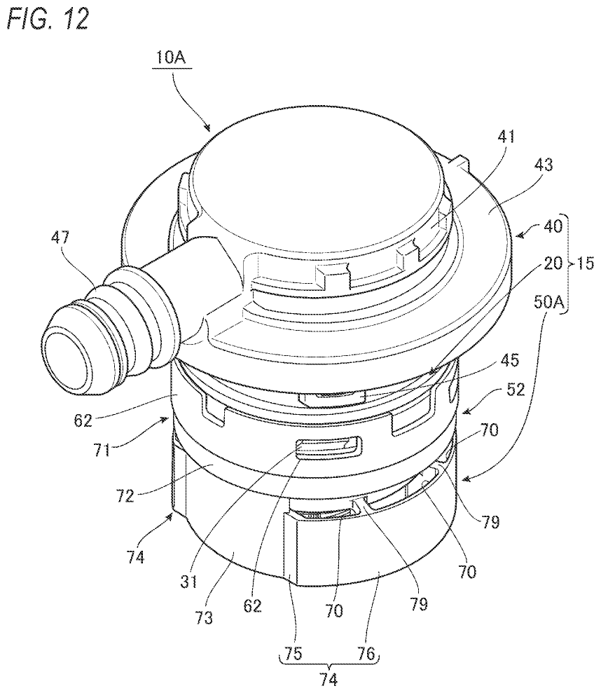

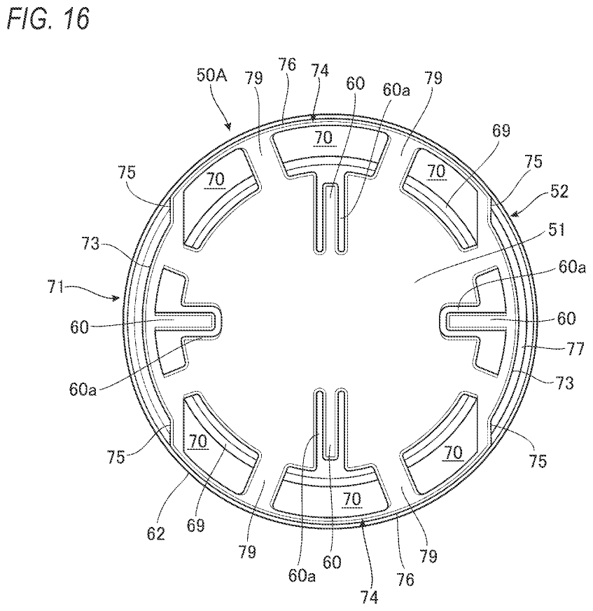

FIGS. 12 to 18 show another embodiment of the valve device for the fuel tank according to the present invention. The same reference signs are given to substantially the same parts as those in the above embodiment, and the description thereof will be omitted.

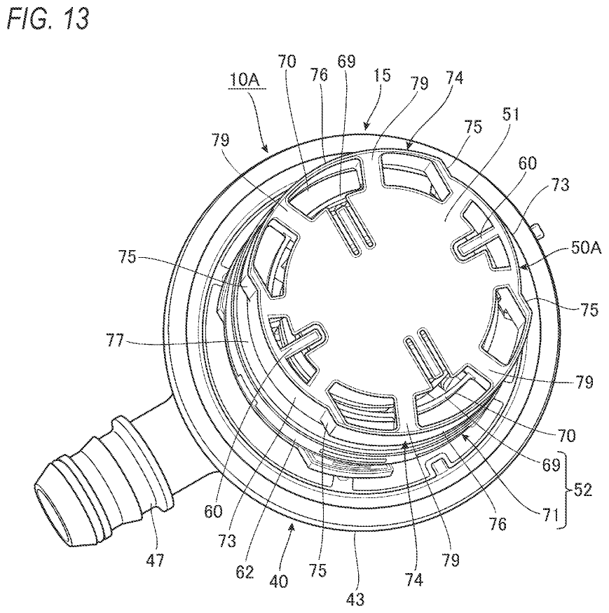

As shown in FIGS. 12 and 13, a valve device 10A for a fuel tank (hereinafter, simply referred to as a “valve device 10A”) of the present embodiment is mainly different from the above embodiment in a shape and structure of a lower cap 50A.

In the present embodiment as well, similarly to the above embodiment, the peripheral wall portion 52 has a double-wall structure including the inner wall portion 69 and the outer wall portion 71.

The outer wall portion 71 in the present embodiment includes the upper end portion 62 disposed upward in the axial direction, an intermediate portion 72 connected below the upper end portion 62 and having a diameter smaller than that of the upper end portion 62, and a lower end portion connected below the intermediate portion 72. Further, the lower end portion of the outer wall portion 71 includes a pair of arc-shaped wall portions 73, 73 and a pair of expansion wall portions 74, 74.

Specifically, the pair of arc-shaped wall portions 73, 73 that have an arc shape and extend in the axial direction are erected from portions facing each other in the radial direction on an outer peripheral edge of the float valve support portion 51. The arc-shaped wall portion 73 has a diameter smaller than that of the intermediate portion 72 of the outer wall portion 71. At positions orthogonal to the pair of arc-shaped wall portions 73, 73 on the outer peripheral edge of the float valve support portion 51, the pair of expansion wall portions 74, 74 that expand outward in a radial direction from the arc-shaped wall portions 73 are provided.

Each of the expansion wall portions 74 includes a pair of outward extending portions 75, 75 that extend outward in the radial direction in parallel with each other from an end in a peripheral direction of a predetermined arc-shaped wall portion 73 and an end in a peripheral direction of an arc-shaped wall portion 73 adjacent to the end in the peripheral direction, and an arc-shaped portion 76 that has a substantially arc shape and connects the pair of outward extending portions 75, 75. Each of the arc-shaped portions 76 is formed with an outer diameter substantially equal to an outer diameter of the intermediate portion 72 constituting the outer wall portion 71.

As shown in FIG. 12, an upper end of the expansion wall portion 74 is positioned in the axial direction lower than an upper end of the arc-shaped wall portion 73.

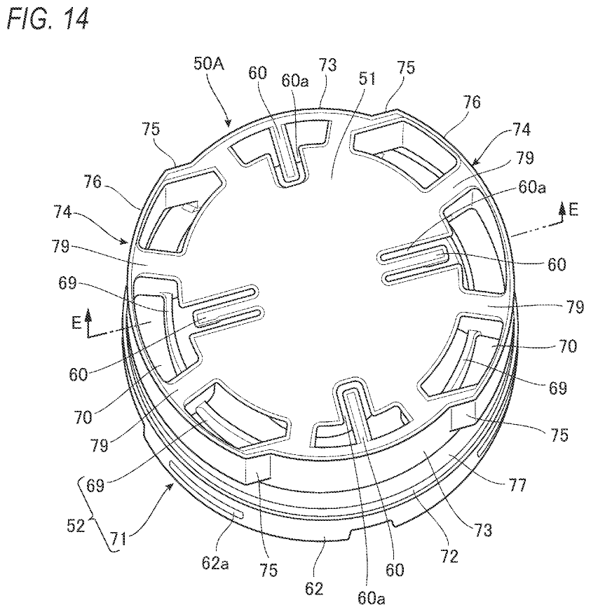

A stepped portion 77 having a substantially annular flange shape protrudes inward in a radial direction from an inner periphery of a lower end portion in the axial direction of the intermediate portion 72 constituting the outer wall portion 71 (see FIGS. 13 and 14). As shown in FIG. 14, a portion of the stepped portion 77 corresponding to the arc-shaped wall portion 73 is connected to an outer periphery of an upper end portion of the arc-shaped wall portion 73.

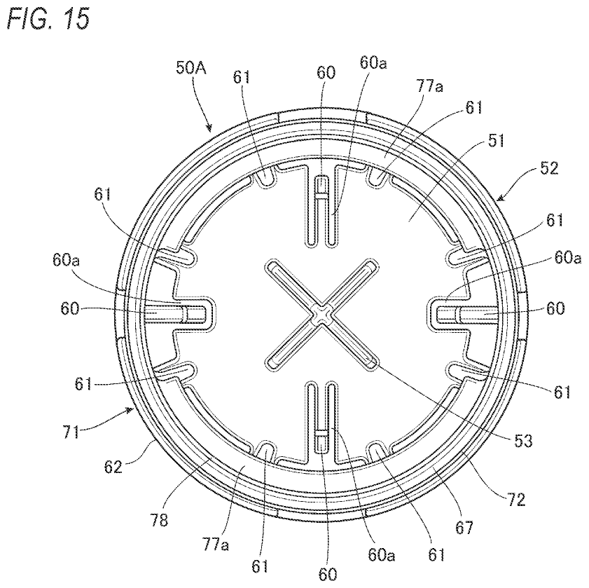

As shown in FIG. 15, a portion of the stepped portion 77 that is not connected to the arc-shaped wall portion 73 forms a protruding portion 77a protruding inward in a radial direction of the outer wall portion 71.

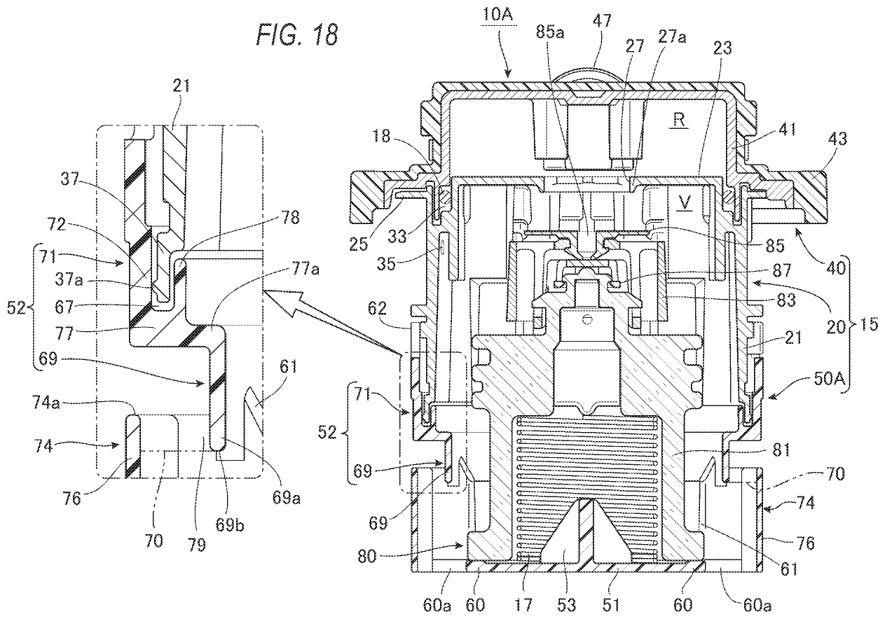

Further, an annular wall portion 78 having an annular shape protrudes upward in the axial direction by a predetermined height from a predetermined position in a radial direction of the stepped portion 77 (see FIG. 18), and an annular groove 67 having an annular shape is formed between the annular wall portion 78, the stepped portion 77, and the intermediate portion 72.

As shown in FIG. 18, the inner wall portion 69 extending in a substantially arc shape extends downward from an inner peripheral edge of the protruding portion 77a of the stepped portion 77. As shown in FIG. 18, a lower end portion 69a of the inner wall portion 69 overlaps with an upper end portion of the outer wall portion 71 by a predetermined length in the axial direction. Here, the lower end portion 69a of the inner wall portion 69 overlaps with an upper end portion of the expansion wall portion 74 provided at the lower end portion of the outer wall portion 71 by a predetermined length in the axial direction.

As shown in FIG. 18, a lower end 69b of the lower end portion 69a of the inner wall portion 69 is positioned in the axial direction lower than an upper end 74a of the expansion wall portion 74 of the outer wall portion 71.

The full tank regulation opening 70 is provided between the lower end portion 69aof the inner wall portion 69 and the outer wall portion 71.

To explain a height position of the full tank regulation opening 70, as shown in FIG. 18, the full tank regulation opening 70 is disposed between the lower end 69b of the lower end portion 69a of the inner wall portion 69 and a predetermined portion of the expansion wall portion 74 of the outer wall portion 71 corresponding to the lower end 69b. The full tank regulation opening 70 is positioned at a position indicated by a two-dot chain line in FIG. 18, and a full tank regulation level, a lock point, or an SOH can be set.

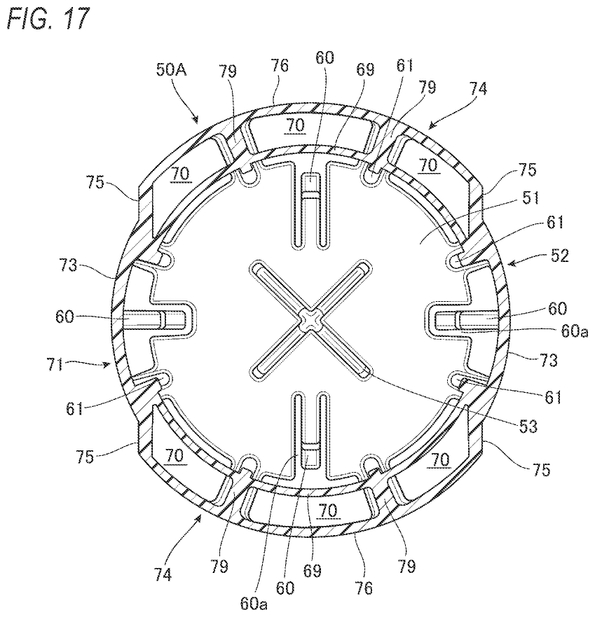

The full tank regulation opening 70 is surrounded by the following portions. That is, as shown in FIG. 17, when the lower cap 50A is viewed from a cross section taken along line E-E in FIG. 14, the full tank regulation opening 70 is defined inside a portion surrounded by the arc-shaped portion 76 and the pair of outward extending portions 75, 75 of the expansion wall portion 74 of the outer wall portion 71 and a portion of the inner wall portion 69 corresponding to the arc-shaped portion 76 and the outward extending portion 75.

Further, the peripheral wall portion 52 includes the connection rib 79 that connects the inner wall portion 69 and the outer wall portion 71 and partitions the full tank regulation opening 70 into a plurality of sections.

As shown in FIG. 17, the connection rib 79 in the present embodiment protrudes from an inner periphery of the expansion wall portion 74 of the outer wall portion 71 toward a center in a radial direction of the lower cap 50A and is connected to the inner wall portion 69, and a plurality of the connection ribs 79 are provided so as to partition the full tank regulation opening 70 into a plurality of sections.

In the present embodiment, the plurality of connection ribs 79 are disposed inside a portion surrounded by the arc-shaped portion 76 and the pair of outward extending portions 75, 75 of the expansion wall portion 74 and the inner wall portion 69, and a plurality of full tank regulation openings 70 are defined. Here, three full tank regulation openings 70 are defined by two connection ribs 79.

As described above, an upper end portion of each of the connection ribs 79 connects the expansion wall portion 74 of the outer wall portion 71 and the inner wall portion 69, but extends downward in the axial direction of the outer wall portion 71, and a lower end portion thereof is connected to the float valve support portion 51 (see FIGS. 13 and 14).

In the valve device 10A according to the present embodiment as well, similarly to the description as above, the full tank is regulated by the full tank regulation opening 70.

In the present embodiment, as shown in FIG. 18, the full tank regulation opening 70 is provided between the lower end portion 69a of the inner wall portion 69 and the outer wall portion 71. Therefore, it is easy to form the outer wall portion 71 positioned on the outside of the full tank regulation opening 70 relatively high, so that it is possible to make it more difficult for the fuel to flow into the valve chamber V when the fuel oscillates or the like.

Further, in the present embodiment, as shown in FIG. 17, the peripheral wall portion 52 includes the connection ribs 79 that connect the inner wall portion 69 and the outer wall portion 71 and partition the full tank regulation opening 70 into a plurality of sections.

According to the above aspect, since the peripheral wall portion 52 includes the connection ribs 79 that connect the inner wall portion 69 and the outer wall portion 71 and partition the full tank regulation opening 70 into a plurality of sections, for example, when the fuel flows into the full tank regulation opening 70 from an obliquely upper side or an obliquely lower side along the peripheral wall portion 52, the fuel is likely to collide with the connection ribs 79, so that the fuel is less likely to directly flow into the valve chamber V.

The present invention is not limited to the embodiments described above, various modifications can be made within the scope of the gist of the present invention, and such embodiments are also included in the scope of the present invention.

What is claimed is:

1. A valve device for a fuel tank comprising:
a housing including a peripheral wall portion and a partition wall, in which
a valve chamber that is configured to communicate with an inside of the fuel tank and that is provided below the partition wall, and a ventilation chamber that is configured to communicate with an outside of the fuel tank and that is provided above the partition wall, are provided within the peripheral wall portion, and
an opening through which the valve chamber is to communicate with the ventilation chamber, is formed in the partition wall; and
a float valve that is accommodated in the valve chamber so as to be able to rise and descend to open and close the opening, and that rises to close the opening when refueling the fuel tank from a refueling nozzle, wherein
the housing includes a float valve support portion that supports the float valve,
a full tank regulation opening that opens in an axial direction and that is configured to allow the inside of the fuel tank and an inside of the valve chamber to communicate with each other, is formed in the peripheral wall portion above the float valve support portion, and
the full tank regulation opening enables continuous refueling from the refueling nozzle when the full tank regulation opening is not immersed, and stops the continuous refueling when the full tank regulation opening is immersed.

2. The valve device for the fuel tank according to claim 1, wherein
the peripheral wall portion includes an inner wall portion and an outer wall portion disposed outside the inner wall portion, and has a double-wall structure when the housing is viewed from a cross section in a radial direction, and
the full tank regulation opening is provided between the inner wall portion and the outer wall portion.

3. The valve device for the fuel tank according to claim 1, wherein
the full tank regulation opening has an arc shape when the housing is viewed in the axial direction.

4. The valve device for the fuel tank according to claim 1, wherein
the housing includes a housing main body including the partition wall, and a lower cap attached below the housing main body, and
the full tank regulation opening is provided in the lower cap.

5. The valve device for the fuel tank according to claim 2, wherein
the full tank regulation opening is provided between a lower end portion of the outer wall portion and the inner wall portion.

6. The valve device for the fuel tank according to claim 2, wherein
the full tank regulation opening is provided between a lower end portion of the inner wall portion and the outer wall portion.

7. The valve device for the fuel tank according to claim 5, wherein
an intermediate wall portion is provided between the lower end portion of the outer wall portion and the inner wall portion and above the full tank regulation opening via a stepped portion so as to reduce a flow path width of a flow path configured to communicate with the full tank regulation opening and the valve chamber.

8. The valve device for the fuel tank according to claim 2, wherein
the peripheral wall portion includes a connection rib that connects the inner wall portion and the outer wall portion and that partitions the full tank regulation opening into a plurality of sections.
